(19) United States
(12) Patent Application Publication
(10) Pub. No.: US 2009/0044220 A1
(43) Pub. Date: Feb. 12, 2009

(54) CREATING SHORTLISTS FOR CONTROL OF A BROADCAST RECEIVER

(75) Inventors: Michael Walter Paul D'hoore, Leuven (BE); Teunis Den Ouden, Ovar (PT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,411

(22) PCT Filed: Nov. 3, 2005
(86) PCT No.: PCT/IB05/53589

§ 371 Date: May 2, 2007

(30) Foreign Application Priority Data
Nov. 9, 2004 (EP) 04105635.9

(51) Int. Cl. H04N 5/445; H04N 5/44

(52) U.S. Cl. 725/38; 348/734; 348/731; 340/2.4

(57) ABSTRACT

A remote control device controls the tuning of a broadcast receiver to a plurality of broadcast channels. The device has a configuring mode for creating a set of specific broadcast channels, and an operational mode for restricting selection from among the channels to the specific channels only. In the configuring mode the device controls the receiver to tune to a candidate channel for providing visual or auditory feedback about the content available from the candidate channel. This feedback facilitates deciding on whether or not to have the candidate channel belong to the set.

### FIELD OF THE INVENTION

The invention relates to a control device for control of a receiver of content information supplied by multiple channels, e.g., a broadcast receiver such as a television receiver (TV), a radio receiver, a set top box (STB), a multimedia PC (MMPC) or a receiver for receiving streamed content from stations on the Internet, etc. The invention further relates to a system comprising a receiver and a control device, and to a method of controlling the receiving of content available from a plurality of channels.

### BACKGROUND ART

U.S. Pat. No. 6,037,877 discloses a channel organizer that enables the user of a television remote control to define a scrolling loop of selected channels as a subset of the available channels using the channel-up and channel-down functions. By entering a loop designation, scrolling is enabled on the television only for those channels included in the subset, thereby skipping unwanted channels, and positioning channel numbers with or without regard to numerical sequence order.

In order to configure this known organizer, the user presses a key “LOOP”, a numeric key corresponding to an unused loop designation such as “2” and then presses the “ENTER” key. The organizer responds by storing loop data representative of the “loop 2” designation in its memory. The user then selects those channels to be included in loop 2. This is accomplished by pressing a key “ADD”, the numeric key or keys corresponding to the channel number such as “4” and “8” as the channel designation for channel 48, and then the “ENTER” key. In response, the organizer stores channel data representative of the channel designation “48” in its memory in association with the loop data for loop 2. This process is repeated to add additional channels.

As an alternative, the “channel UP” and “channel DOWN” keys can be used to add channels to the loop. The user presses the “ADD” key, then the “channel UP” or “channel DOWN” key to scroll through a plurality of channels and then presses the “ENTER” key. This adds all of those channels that were scrolled to the channel loop.

With a loop defined such as loop 2 above, scrolling is enabled for the “channel UP” and “channel DOWN” keys only for those channels in the subset. Continued activation of “channel UP” continues the scrolling through channels in a closed loop. Activation of the “channel DOWN” initiates the scrolling through these channels in reverse order. As this procedure indicates, the channels in a given subset can be arranged in any desired order, without regard to numerical sequence. The procedure for deleting channels is the same as that for adding a channel except for pressing a “DELETE” key.

For the purpose of user feedback and editing, the organizer communicates with a television set to have displayed on the television's display monitor the information about the channels (e.g., the channel numbers) added to the loop being created or being edited.

### SUMMARY OF THE INVENTION

One of the objects of the invention is to provide a channel organizer system that has a user interface as an alternative to the known one, and that is also believed to be more ergonomic. To this end, the inventors provide a device for control of a broadcast receiver for receiving content from a plurality of broadcast channels. The device has a configuring mode for enabling to create a set of specific ones of the broadcast channels. The device also has an operational mode different from the configuring mode. In the operational mode the set serves to restrict selecting among the channels to the specific channels only. In the configuring mode the device controls the receiver to tune to a candidate channel among the plurality of channels for providing feedback (e.g., visual or auditory) to the user through the content available from the candidate channel tuned into. This facilitates deciding on whether or not to have the candidate channel belong to the set. Instead of information about the channel, e.g., the channel number, being rendered on the display of the television set during set up as in the known system, the user of the invention is now browsing the channels during configuration of the control device and can select a channel for being added to or deleted from the set, based on the channel's content being broadcast.

Preferably, at least one of a channel-up command and a channel-down command allows browsing the plurality of channels in the configuration mode for searching the candidate channel. Note that these commands in the known organizer device play a different role during the set up. In the known device, these commands serve to select a range of numerically adjacent channels for adding the range to a loop. Accordingly, the simple browsing feature of the invention is not available at the known device.

Preferably, the configuring mode enables to create a further set of further specific ones of the channels for restricting the selecting among the channels in the operational mode to the further specific channels only, and wherein the device enables to select the set or the further set in the operational mode.

The concept in the invention can also be used in a system comprising a broadcast receiver and a control device for control of the receiver. Preferably, the control device is physically integrated with the receiver, e.g., accommodated in the same housing as the receiver. For example, the control device is comprised in the user interface of the receiver. Such a system embodiment is relevant to, e.g., portable or mobile receivers.

The concept of the invention can also be implemented in a service, e.g., on a data network. The invention relates then to a method of controlling the receiving of content, by a party such as an end-user, from a plurality of broadcast channels. The method comprises enabling to create a set of specific ones of the plurality of broadcast channels in a configuring mode, for restricting a selection from among the plurality of channels to the specific channels in the set in an operational mode. The enabling to create comprises enabling to tune to a candidate channel among the plurality of channels for receiving feedback about the content available at the candidate channel in order to facilitate deciding on whether or not to have the candidate channel belong to the set. In an example of this embodiment, the processing of the user's selections as entered and the tuning are operations carried out at the service provider's side under control of the user's input.

### BRIEF DESCRIPTION OF THE DRAWING

The invention is explained in further detail, by way of example and with reference to the accompanying drawing wherein:

FIGS. 1-4 are diagrams illustrating operations in a system in the invention; and

FIG. 5 comprises diagrams illustrating embodiments of a system in the invention.

Throughout the figures, same reference numerals indicate similar or corresponding features.

### DETAILED EMBODIMENTS

One of the embodiments of the invention relates to a programmable remote control device used for selecting, and zapping through, channels on an electronic device such as a TV, radio STB, MMPC, etc. In order to reduce the complexity and to increase the user-friendliness, there is a need for remote control devices that can be easily set up or configured for selecting from, or scroll through, a list of favorite channels. Typical approaches are known from the “Weemote” remote control device for children, and from WO9515028. The former limits the number of accessible channels through the remote control device, especially useful for children; the latter attempts to reduce perceived complexity by limiting the number of keys on a remote control.

The invention allows an intuitive set up process to select favorite channels by means of tuning the controlled receiver to a channel during set up, so as to make the content available from that channel visible or audible. This setting up allows reducing and reordering the available channels, e.g., based on favorability. The benefit after setup is an easier channel selection and better zapping experience.

In the configuration mode (or: set up mode), the remote control device allows running through the channels available on the controlled device (or receiver) by sending the proper commands (e.g., in infrared (IR) or radio frequency (RF) codes) corresponding to the channel numbers. A sequence of respective IR or RF codes corresponds to the sequence of respective channel numbers. This can be achieved by pressing the “channel up” key or “channel down” key of the remote control device, or by entering the channel number directly via the number keys. What is interesting is the direct feedback given by the controlled receiver to the person manipulating the remote control device in the configuration mode. The person can actually see or hear the candidate channel's content in order to decide whether or not to select this channel currently tuned into for inclusion into the set of favorite channels. If during this process a channel is identified that is a favorite and that is not yet a member of the set, it is added to the set through a proper user input to the control device (e.g., an “add” key or another key or another user-input). If the current channel is a member of the set but should not belong to it (owing to the user's taste having changed or because the user wants another classification of channels) the channel is eliminated from the set of favorite channels through a proper input (a “delete” key or another key or another input to the control device).

To illustrate the invention, an example is discussed below of the operation of a control device in the invention, here a remote control device that uses IR for communication with a TV receiver.

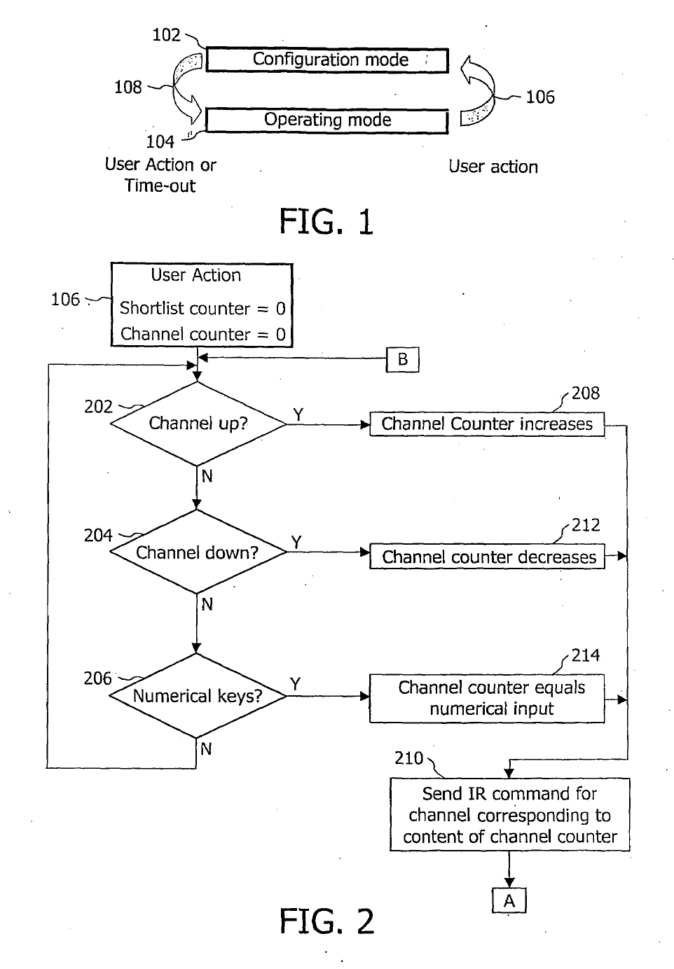

FIG. 1 is a diagram illustrating the toggling between a configuration mode 102 (or: set-up mode) and an operational mode 104. As discussed above, the configuration mode is assumed to configure the control device for operational use. The operational mode is assumed for operational use of the control device. In order to transition from operational mode 104 to configuration mode 102, as indicated by arrow 106, a specific user action is required. Configuration mode 102 is entered upon a user action that is not likely to happen inadvertently. This could be accomplished by, e.g., having the user activate a key or switch on the control device that is not easily accessible; when a battery is being inserted, by pressing a key or a combination of keys for a time period that is typically longer than would happen in operational use of the control device; pressing a particular combination of keys; etc. An indicator at the remote control device (giving e.g., a light or a sound) could indicate that the remote control device has been put into configuration mode 102. Transitioning from configuration mode 102 to operational mode 104 as indicated by arrow 108, can be achieved by, e.g., another specific user action or upon expiry of a predetermined time period wherein user inputs have not been detected by the remote control device.

In configuration mode 102, the user manipulates the remote control device to create a set representative of specific broadcast channels. The set is used in operational mode 104 for restricting selection from the available channels to the specific ones in the set, upon this set itself having been selected. In the discussion of the example, the set is also being referred to as “shortlist” in the drawing.

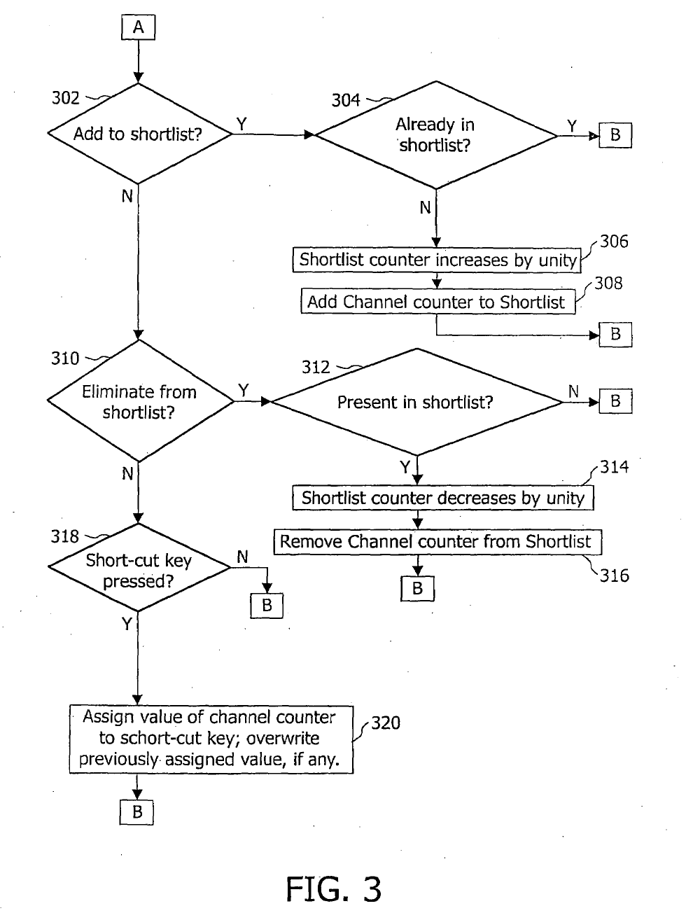

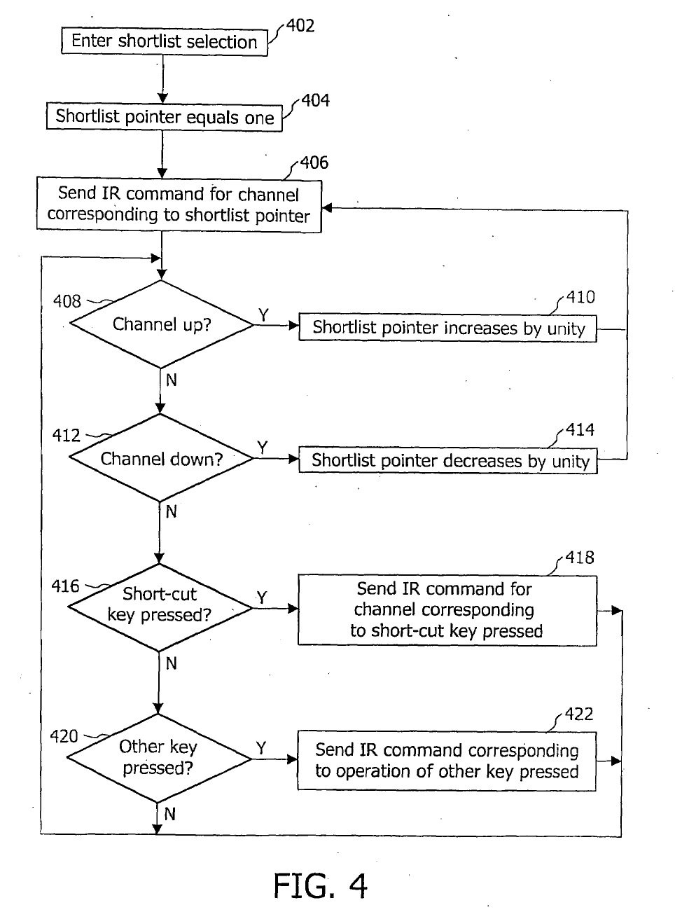

FIGS. 2 and 3 form a flow diagram to illustrate the operations in the configuration mode. In FIG. 2, a step 106 is representative of entering the configuration mode upon the user providing a specific input to the control device. It is assumed that there is not yet a shortlist created. The shortlist counter, which serves to count the number of channels adopted into the shortlist, is set to zero. In operational mode 104, the shortlist counter also functions as a pointer to the channels in the shortlist as is discussed below with reference to FIG. 4. In step 106 the channel counter is set to zero. The channel counter keeps track of which channel is being considered as a candidate for being added to the shortlist. The remote control device checks in a step 202 if the user has entered the “channel-up” command, in a step 204 if the user has entered the “channel-down” command, and in a step 206 whether the user has entered a numerical value indicative of a channel number. If in step 202 the “channel-up” command was detected the channel counter is increased by unity in a step 208 and the IR command is sent to the TV corresponding to the content of the channel counter in a step 210. As a result the TV tunes to the next higher channel. Similarly, if a “channel-down” command was detected in step 204, the channel counter is decreased in a step 212 and an IR command is sent in step 210 to switch the TV to the next lower channel. If the channel counter was zero before the “channel-down” command was given, the decrease is either zero or the channel counter is set to the channel with the highest number available. In the latter case, the channels can be traversed in a loop. A similar implementation can be used for the “channel-up” route when the process has reached the channel with the highest number. In case the control device has got numerical keys, and if a numerical value was entered in step 206, the channel counter is set to this numerical value in a step 214 and the IR command is sent in step 210 to tune the TV to the channel whose channel number is assumed by the channel counter. If no entry is detected in steps 202-206, the control device will traverse the loop consisting of steps 202-206 until the user enters an input or until the timer expires in step 108. The commands of step 210 are the commands conventionally sent in operational use of the control device, e.g., a conventional remote control device that came with the TV receiver as purchased.

After step 210 in FIG. 2 the process continues with the process illustrated in FIG. 3. The block with designation “A” indicates the entry point of FIG. 3 where it connects with FIG. 2.

In a step 302 the remote control device checks if the user has indicated that the channel currently tuned into is to be added to the shortlist. The user now can actually watch the program being broadcast on that channel. The program is assumed to be in general representative of the content made available on that channel for the purpose of this invention. If the remote control device detects in step 302 that it is to add the current channel to the shortlist upon the user having entered a command to do so, it is checked in a step 304 if the channel is already present in the shortlist. If it is, the user may receive a warning and the process returns to the steps of FIG. 2. The block with the letter “B” indicates the entry point of FIG. 2 where it connects with FIG. 3.

If the current channel is not present in the shortlist, a shortlist counter is increased by unity in a step 306 and the value in the channel counter is added to the shortlist in a step 308, whereupon the process returns to the steps of FIG. 2.

If it is decided in step 302 that the current channel is not to be added to the shortlist, it is determined in a step 310 whether the current channel is to be deleted from the shortlist. If the current channel is to be deleted according to an input from the user, it is checked in a step 312 if the current channel is present in the shortlist. If it is not present, the process returns to FIG. 2, entry point “B”, preferably after providing an indication to the user. If it is determined in step 312 that the current channel is present in the shortlist, the shortlist counter is decreased by unity in step 314 and the channel indicated by the value in the channel counter is removed from the shortlist in a step 316. The process then continues with entry point “B” of FIG. 2.

If in step 310 it is decided that the current channel is not to be deleted from the shortlist, it is determined in a step 318 whether a short-cut key was pressed. This is an option available to control devices that have a separate key (hard button or soft key) for being assigned to a particular one of the channels. If the short-cut key was pressed the value of the channel counter is assigned to the short-cut key in a step 320, and any previous value assigned to the short key is overwritten. Steps 318-320 are embedded in the configuration mode as a separate branch for configuring the short-cut keys in parallel to the creating of the shortlists. Two or more short-cut keys can be provided on the control device, each of which can be programmed as just described.

Of course, steps 306-308 can be carried out in reverse order; similarly, steps 314-316 can be carried out in reverse order. Likewise, the order of decision steps 302, 310 and 318 can be changed. Further, there may be conditions under which it is preferable to change the order of decision steps 202-204-206.

Accordingly, through simple user interaction, for example a simple key press, the current channel number is added to a shortlist and/or assigned to a short-cut key being pressed. Relevant is here that the remote control device knows the channel number because the number is representative of the specific channel selected via the IR codes transmitted. As an option, a simple user interaction (e.g., simple key press) the current channel numbers can be eliminated from the shortlist and/or un-assigned from the key (i.e., short cut key).

FIG. 4 is a diagram illustrating operational mode 104. In a step 402 the user has put the control device into a state for selecting a channel from a shortlist (or: set) that was created as described under FIGS. 2 and 3 discussed above. The pointer of the shortlist is set to unity in a step 404. In a step 406 the IR command is then sent to tune the receiver to the channel occupying the position in the shortlist referred to by the shortlist pointer. Here it is the channel at position “one”. This could be done without any noticeable delay or with a delay to give the user the opportunity to expedite the selection of a channel in this shortlist at a higher position. In a step 408 it is determined whether the “channel-up” key was pressed. If so, the shortlist pointer is increased by unity in a step 410, and in step 406 an IR command is sent to the TV corresponding to the channel indicated by the shortlist pointer. Then the process returns to step 408. If “channel-up” was not pressed, it is determined in step 412 whether “channel-down” was pressed. If so, the shortlist pointer is decreased by unity in a step 414, and in step 406 an IR command is sent to the TV corresponding to the channel indicated by the shortlist pointer. Then the process returns to step 408. If the “channel-down” key was not pressed it is determined in a step 416 if a short-cut key was pressed. If a short-cut key was pressed the relevant IR command is sent in a step 418 and the process returns to step 408. If the short-cut key was not pressed, it is determined in a step 420 if a key, other than the “channel-up” key, “channel-down” key or a short-cut key was pressed. If so, the appropriate action is taken, e.g., the sending of the corresponding IR command as in a step 422, whereupon the process returns to step 408.

Accordingly, after a shortlist has been created in setup mode 102, the “channel up” and “channel down” keys select the next higher or next lower channel in the shortlist, and cause the IR codes corresponding to the selected channel to be transmitted to the receiver.

Optionally, upon pressing the key that has the function to activate the device, the IR codes corresponding to the first channel number in the short list are sent after a reasonable start up time so that the receiver immediately starts with a favorite channel.

Optionally, if the control device has not yet been configured in mode 102 yet or is reset, the “channel up” and “channel down” keys can have the same function as in the original remote control device.

Optionally, the numerical keypad (if present) can be disabled in operating mode 104 once the shortlist has been created in mode 102, for example in order to further extend parental control.

Preferably, the control device has a “reset” input., The reset is activated by a user action that is not likely to happen by accident. The reset clears the shortlist and/or un-assigns all channels assigned to their respective short-cut keys.

Above example of the invention illustrates the creation of two categories of the channels: favorites and their complement. The favorites then can be zapped as a short-list and selection of a proper program is facilitated.

Preferably, the grouping of channels is personalized per individual user. The control device then has a different operational mode per different user. A specific user is identified e.g., through a fingerprint sensor, or through entering a specific access code for entering the personal operational mode or any other discriminating means. The specific user is then enabled in the set-up mode to configure his/her specific favorites list as has been described above for a single user, and to use it accordingly.

Preferably, more than two categories of channels can be created. In above example, the two categories considered are the favorites accommodated in the shortlist and their logic complement. Consider now for examples TV channels, radio channels or other content information sources that can be grouped according to, e.g., (broadcasting) language or country of origin; the genre of the programs or content, presence or absence of commercial breaks. Preferably, therefore the control device enables to create multiple shortlists in order to take into account the various groupings of channels and/or other content sources. Within this context, see e.g., patent document publication WO 01/86948 for ELECTRONIC CONTENT GUIDE RENDERS CONTENT-RESOURCES TRANSPARENT (attorney docket US 000106), filed as U.S. Ser. No. 09/568,932 and incorporated herein by reference. This publication relates to a data management system on a home network that collects data descriptive of content information available at various resources on the network. The data is combined in a single menu to enable the user to select from the content, regardless of the resource.

As for the language of the content, the user may want to cluster broadcasting channels in shortlists according to the language spoken by the news anchors or the TV show hosts so as to be able to zap through this collection of channels only while seeking a proper program in the proper language. In Western Europe, for example, channels are available in a package that covers the following languages: English, Welsh, German, French, Dutch, Italian, etc. Within this context, see e.g., U.S. Pat. No. 6,519,564 and U.S. Pat. No. 6,772,124 for CONTENT-DRIVEN SPEECH-OR AUDIO-BROWSER (attorney docket PHA 23,700), herein incorporated by reference. These patents relate to searching the Internet in order to find resources that provide streamable audio such as live Internet broadcasts. The resources are identified based on their file extension and are categorized according to, e.g., the natural language or music style. The user is enabled to browse the collection based on textual or musical input.

As for genre, some channels are dedicated to news and weather forecasts only, or predominantly, to sports only or predominantly, or to science and nature only or predominantly, or to music only or predominantly, to movies only or predominantly, etc. It may therefore be desirable to cluster the available channels together depending on the genre and thus to create several shortlists. A user who feels like watching a sports program then selects the cluster “sports” for subjecting it to the zapping or selection operation. Setting up then can be done as specified above under the favorite selection by a single user, and assigning a specific key on the control device to a specific cluster of channels or sources that relate to sports. The keys may be provided on the control device as marketed, or can be programmed by the end user or by a service if the control device is a universal programmable remote control device with a touch screen user interface such as the ones in the Pronto family of Philips Electronics.

A further extension is that the categorizing may be made dynamic in the sense that it changes depending on, e.g., the time of the day or the day of the week. For example, the short-list is set up for the time slot from 5 am to 7 pm to comprise only the channels that broadcast programs suitable for being watched by children younger than 12, plus the news channels. For the time slot after 7 pm, the favorites shortlist is set up to comprise all the channels available, or the channels that are likely to be of interest to a more mature audience. Within this context, see e.g., US patent application publication 20020133821 (attorney docket US 018028), incorporated herein by reference. This patent document relates to determining electronic content information and the time slots for play-out based on the activities scheduled in the user's electronic calendar and the user's profile or declared interests. In this manner, the recording and downloading of content is automated based on the user's life style.

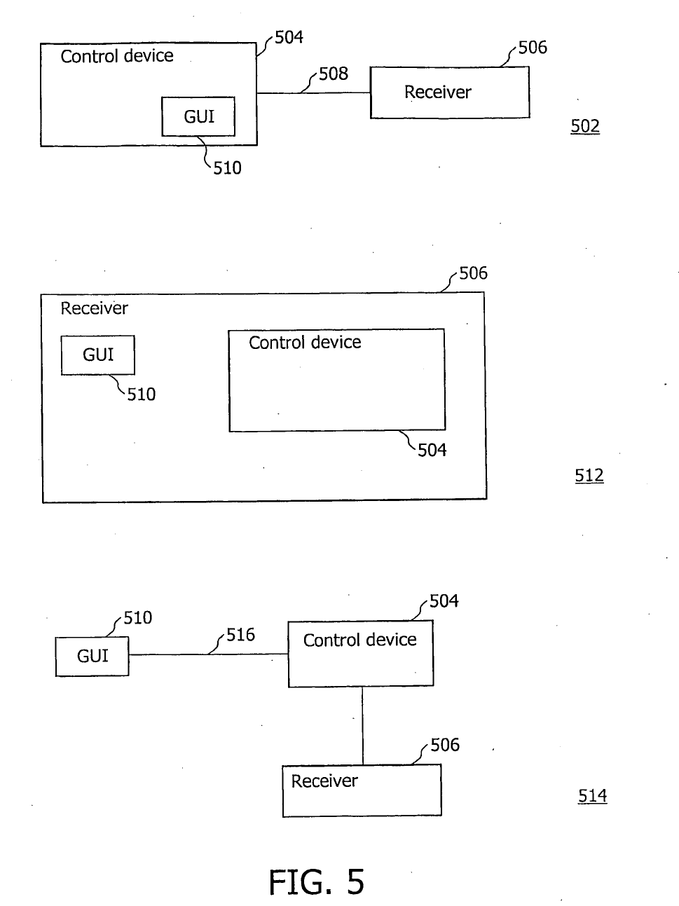

FIG. 5 comprises diagrams of several embodiments of the invention. An embodiment 502 comprises a control device 504 and a receiver 506 that communicate via a connection 508. Connection 508 is a wired connection, such as a cable or a network, or a wireless connection such as implemented using IR or RF, or a hybrid combination of wired and wireless connections. Control device 504 comprises a user interface 510, preferably a graphical user interface e.g., hard buttons and/or soft buttons rendered on a touch screen. A typical example of embodiment 502 is one wherein control device 504 comprises a remote control device, wherein receiver 506 comprises a TV or a radio, and wherein connection 508 is a wireless IR connection.

In an embodiment 512 receiver 505, control device 504 and user interface 510 are accommodated within the same physical apparatus. A typical example of this configuration is a mobile receiver or a mobile player.

In an embodiment 514 the user interacts with control device 504 and receiver 506 via a network 516. Control device may then be a software application running on a server. The method as specified by the invention is relevant to commercial exploitation of this embodiment.

1-11. (canceled)

12. A device for control of a broadcast receiver for receiving content from a plurality of broadcast channels, wherein the device has a configuring mode for enabling to configure the device so as to create a set of specific ones of the broadcast channels, and an operational mode that is different from the configuring mode and wherein the set serves to restrict selecting among the channels to the specific channels only; and wherein in the configuring mode the device controls the receiver to tune to a candidate channel among the plurality of channels for providing feedback about the content available from the candidate channel for facilitating deciding on whether or not to have the candidate channel belong to the set.

13. The device of claim 12, wherein at least one of a channel-up command and a channel-down command allows browsing the plurality of channels in the configuration mode for searching the candidate channel.

14. The device of claim 12, wherein the configuring mode enables to create a further set of further specific ones of the channels for restricting the selecting among the channels in the operational mode to the further specific channels only, and wherein the device enables to select the set or the further set in the operational mode.

15. A system comprising a broadcast receiver for receiving content from a plurality of broadcast channels and a device for control of the broadcast receiver, wherein the device has a configuring mode for enabling to configure the device so as to create a set of specific ones of the broadcast channels, and an operational mode different from the configuring mode, wherein the set serves in the operational mode to restrict selecting among the channels to the specific channels only; and wherein in the configuring mode the device controls the receiver to tune to a candidate channel among the plurality of channels for providing feedback about the content available at the candidate channel for facilitating deciding on whether or not to have the candidate channel belong to the set.

16. The system of claim 15, wherein the device for control is physically integrated with the receiver.

17. The system of claim 16 for use as a mobile system.

18. The system of claim 15, wherein at least one of a channel-up command and a channel-down command allows browsing the plurality of channels in the configuration mode for searching the candidate channel.

19. The system of claim 15, wherein the configuring mode enables to create a further set of further specific ones of the channels for restricting the selecting among the channels in the operational mode to the further specific channels only, and wherein the device enables to select the set or the further set in the operational mode.
